(19) United States
(12) Patent Application Publication
(10) Pub. No.: US 2023/0253577 A1
(43) Pub. Date: Aug. 10, 2023

(54) BIPOLAR PLATE AND FUEL CELL

(71) Applicant: Reinz-Dichtungs-GmbH, Neu-Ulm (DE)

(72) Inventors: Robert BLERSCH, Neu-Ulm (DE); Rainer GLUECK, Neu-Ulm (DE); Bernadette GRUENWALD, Neu-Ulm (DE); Claudia KUNZ, Neu-Ulm (DE)

(21) Appl. No.: 18/165,110

(22) Filed: Feb. 6, 2023

(30) Foreign Application Priority Data
Feb. 7, 2022 (DE) 20 2022 100 690.3

(51) Int. Cl. H01M 8/026; H01M 8/0267

(52) U.S. Cl. CPC H01M 8/026; H01M 8/0267

(57) ABSTRACT

A bipolar plate having an anode plate and a cathode plate and a contact surface between the two surfaces. In a transition region, at least one first groove ends and/or a second groove ends or at least one first groove merges into a second groove, wherein the grooves guide fluid. In at least one of the first grooves and second grooves, the groove base rises such that the distance of the groove base from the contact surface decreases.

### CROSS-REFERENCE TO RELATED APPLICATION

The present application claims priority to German Utility Model Application No. 20 2022 100 690.3, entitled “BIPOLAR PLATE AND FUEL CELL”, filed Feb. 7, 2022. The entire contents of the above-listed application is hereby incorporated by reference for all purposes.

### TECHNICAL FIELD

The present disclosure relates to a bipolar plate such as are used in electrochemical systems for converting chemical energy into electrical energy and electrical energy into chemical energy and to a fuel cell having one or more such bipolar plates.

### BACKGROUND AND SUMMARY

Known electrochemical systems normally comprise a stack of electrochemical cells that are each separated from one another by bipolar plates. Such bipolar plates typically have two individual separator plates, an anode plate and a cathode plate, that are joined together while placed on one another. The joining together typically takes place with material continuity, for example by a weld connection.

Such bipolar plates have hollow spaces between the anode plate and the cathode plate in which a coolant can be conducted between the anode plate and the cathode plate. The coolant cannot only serve the cooling as its main object, but also very generally the temperature control of the bipolar plates, for example also to heat the bipolar plate at a very low environmental temperature.

For this purpose, coolant is led into this intermediate space via a passage opening (a port) and is conducted there via a distributor structure into the flow region that takes up a large part of the area between the two plates (anode plate and cathode plate). The flow region is designed such that the anode plate and the cathode plate are temperature controlled in those regions in it in which the electrochemical reaction takes place on the outer side of the bipolar plate.

The coolant is led through the bipolar plate to a further port via channels of a collection region via which the coolant is led off from the intermediate region between the anode plate and the cathode plate.

The valve region, flow region, and collection region have channels for guiding the coolant. The channels of the distribution region and of the flow region or of the flow region and of the collection region merge into one another between the distribution region and the flow region and between the flow region and the collection region, e.g. in the transition regions. Some of the channels are here guided into one another, joined together, and/or separated into further channels.

Such coolant channels are separated from one another by web so that a sequence of webs and of grooves (channels) separated from one another by the webs is produced transversely to the flow direction of the coolant. As already mentioned, some of the channels and thus of the grooves and webs end at or in the transition regions. A pronounced material thinning of the groove walls takes place at the ends of the channels at which the respective channel base (groove base) is merged into the plane of the respective anode plate or cathode plate adjacent to the grooves due to the very large distortion of the plate material there on the stamping of the grooves. Cracks can even occur in some cases due to the large degree of reshaping. Material thinning and cracks result in a smaller permanent durability of the separator plate and in higher waste in the manufacture of separator plates.

The material is moreover curved in two different directions at the groove ends by the stamping process. On the one hand, the wall of the groove is curved transversely to the longitudinal extent of the groove in cross-section and, on the other hand, is also curved in the direction of the longitudinal extent. This results in a very great reshaping of the groove end due to the large stamping radius at the end of the groove that is constant over the total periphery of the groove end.

It is therefore the object of the present disclosure to provide a bipolar plate that has a higher permanent durability and that has a higher process stability and reduced waste in production. It is likewise the object of the present disclosure to provide a fuel cell having such a bipolar plate.

The bipolar plate in accordance with the present disclosure conventionally has two separator plates, an anode plate, and a cathode plate, also called “plates” in summary in the following. The anode plate and the cathode plate are arranged adjacent to one another while forming a contact surface between the mutually facing surfaces of the anode plate and of the cathode plate. The anode plate and the cathode plate may be connected to one another, e.g. in an adhesive manner, welded for example, in a sealing manner continuously along their peripheral margin.

Hollow spaces that are provided, for example, to guide a coolant (more generally “temperature control agent”) are formed between the two plates. These hollow spaces are located in a distribution region adjacent to an inlet port, in a collection region adjacent to an outlet port, and in a flow region arranged between the distribution region and the collection region.

The flow region of each of the plates has a first group of first grooves that extend between the distribution region and the collection region arranged adjacent to one another transversely to their longitudinal directions and separated from one another by first webs. These first grooves in the anode plate and in the cathode plate form flow channels for the coolant in the flow region. All of the grooves are here formed as recesses with respect to the plate plane or the contact surface of the plate with the adjacent plate.

Both the distribution region and the collection region each have a second group of second grooves that extend away from the flow region and are likewise arranged adjacent to one another transversely to their longitudinal directions and separated from one another by second webs. These grooves also form channels for guiding the coolant in these second grooves. The first grooves of the flow region and the second grooves of the distribution region and/or the first grooves of the flow region and the second grooves of the collection region merge into one another in a transition region. An individual second groove can also merge directly into a groove of the flow region in the transition region.

In accordance with the present disclosure, the aforementioned object may now be achieved in that at least one of the first grooves and of the second grooves are formed, starting from the flow region, the distribution region, and/or the collection region, in the direction of the adjacent transition region or in the transition region such that the groove base (bottom) rises in the direction of the contact surface such that the distance of the groove base from the contact surface decreases.

This has the effect that with a groove ending at or in the transition region, the height difference to be overcome between the groove base and the contact surface by the stamping is reduced at the end of the groove in the direction of the transition region or in the transition region so that the degree of reshaping between the groove base and the contact surface at the end of the groove is reduced in comparison with conventional channel structures of the separator plate. A smaller material tension also hereby results. Even if a first groove of the flow region merges into a second groove of the distribution region or of the collection region, the groove base can increase in accordance with the present disclosure in the direction of the contact surface in the direction of the transition region or in the transition region for the first groove and/or the second groove that merge into one another. A smaller degree of reshaping between the groove base and the contact surface is also achieved here in those regions in which one groove merges into the other groove. In addition, differences in the depth of the first groove and the second groove merging into one another can be compensated.

Too high a degree of reshaping and too great a material thinning are thus avoided at the end of a groove or in the transition region from a first groove to a second groove.

It may be advantageous if the region in which the groove base of the respective groove increases in the direction of the contact surface does not fall below a minimum length L1 in the direction of extent of the groove, with the rising of the groove base in the direction of the contact surface extending over at least 1 mm, or at least 1.4 mm. It may be advantageous if this length L1 is greater than the width B of the groove, or greater than 1.2 times the width B of the groove. The width B of the groove is here determined at half the depth of the groove in a region in which the groove base has not yet risen in the direction of the contact surface.

It may be advantageous if the rise of the groove base over a length L2 takes place linearly, e.g. at a predefined angle α with respect to the plane of the contact surface. This angle may amount to α≤10°, or ≤5°. In this embodiment, the stretching of the material related to the raising of the groove is limited, it is however sufficient to shape the groove. Thus, the present disclosure allows avoidance of excessive material thinning due to degrees of reshaping that are too high in the region of the rise of the groove base in the direction of the contact surface or adjacent to this rise.

The ends of the grooves are conventionally chamfered and peripherally rounded in a constant manner with channels that end at or in the transition region. This also results in a high degree of reshaping and in a great material thinning at the respective end of the channel.

This can be avoided or improved if a suitable design of the groove wall is formed in the region of such a groove end/channel end in a cross-section transversely to the longitudinal direction of the groove. It may be advantageous if the respective groove base in this cross-section merges in a first curvature region having a radius R1 into the groove wall, with the latter then extending over an intermediate section, for example an intermediate section that is straight line in cross-section, up to a further second curvature region in which the groove wall having a radius R2 merges into the contact surface or into the adjacent web. R1 may here amount to 0.04 mm to 0.24 mm and/or R2 to 0.11 mm to 0.33 mm. These values may apply on the use of metallic layers having a sheet metal thickness between 50 μm and 200 μm, such as with a sheet metal thickness of 75 μm or 85 μm. A reduction in the material thinning in the groove wall may be achieved by the radius R2 selected as large in the transition from the groove wall to the contact surface (or from the top of the adjacent web).

The respective dimensions and radii specify the radius of the separator plate on the inner side of the groove. Due to the material thickness of the respective plate, the radius on the outer side of the separator plate outwardly disposed with respect to the groove can have different values. It may be advantageous if the radius of the second curvature section on the outer side of the second curvature section amounts to R1. In the same way, the first curvature region can have the radius R2 on its outer side. The two curvature regions may in this case be formed with point symmetry with respect to one another.

If one groove merges into another groove, for example a first groove into a second groove or a second groove into a first groove, the transition region between these two grooves here can also be improved by a suitable design of the groove wall and the groove base in a cross-section transverse to the longitudinal extent of the first and second grooves. For this purpose, a fifth curvature region is formed that has a radius R1′ in which the groove base merges into the groove wall and a sixth curvature region in which the groove wall merges while forming a radius R2′ into the regions of the plate adjacent to the groove, e.g. the contact surface or the top of the adjacent web.

The radius R1′ may amount to 0.225 mm to 0.375 mm and/or the radius R2′ may amount to 0.125 mm to 0.215 mm, where the radii are in turn determined on the inner side of the respective groove. On such a selection of the radii R1′ and R2′, the degree of reshaping and the material thinning is improved or reduced on the transition from the groove base to the contact surface in the transition regions in which one groove merges into another groove.

A suitable formation with point symmetry of fight and sixth curvature regions can again also be provided here so that the fifth and sixth curvature regions each have the radius R2′ or the radius R1′ respectively on their outer sides.

If one of the grooves of the flow region and/or of the distribution region and/or of the collection region ends at or in the transition region, the end of the transition region can thus be designed such that the cross-section through the groove, determined along the longitudinal extent of the groove and measured on the inner side of the groove, has a third curvature region having a radius R3 in which the groove base merges into the groove wall in the transition from the groove base to the contact surface. Suitable values that contribute to an improved material thinning and degree of reshaping in this region are 0.31 mm≤R3≤1.5 mm, such as a radius R3 of 0.525 mm±0.0525 mm.

Finally, the present disclosure also comprises a fuel cell having one or more bipolar plates in accordance with the present disclosure.

Some examples of bipolar plates in accordance with the present disclosure or of elements hereof will now be provided in the following. In this respect, reference numerals that are the same or similar in all the Figures designate the same or similar elements so that their description may not be repeated.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a fuel cell.

FIG. 2 shows a bipolar plate.

FIG. 3 shows a plan view of a separator plate.

FIG. 4 shows a plan view of a conventional separator plate viewed from the outer side of the cathode plate of a detail around a transition region between a distribution region and a flow region.

FIG. 5 shows a detail from the cathode plate in FIG. 4.

FIGS. 6-10 show different views and cross-sections through channel ends of separator plates in accordance with the present disclosure.

FIG. 11 shows a plan view of a transition region between a distribution region or a collection region and a flow region of a separator plate in accordance with the present disclosure.

### DETAILED DESCRIPTION

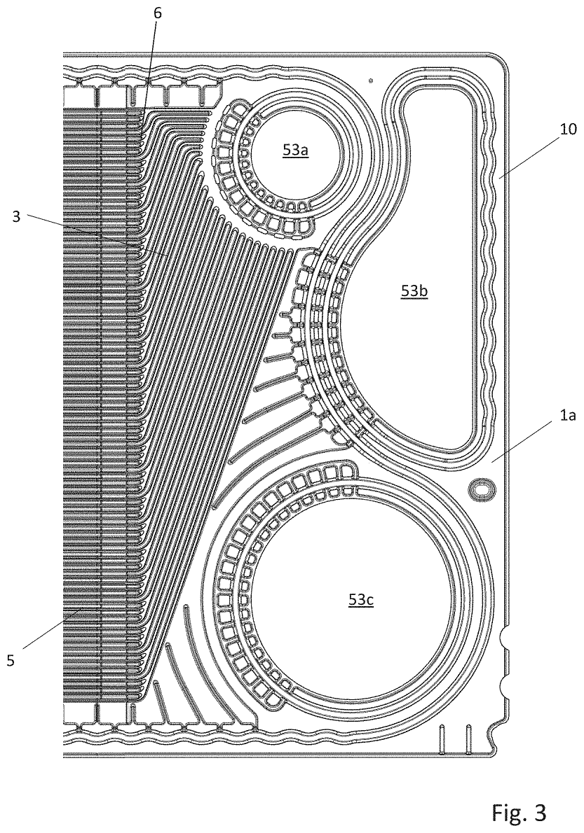

Here and in the following, representations are selected for a simple representation that look at the outer side of a separator plate of a bipolar plate. Consequently, respective webs (lands) and grooves that for example can conduct gases are shown in a positive manner. However, the present disclosure also relates to the design of webs and grooves in a view of the coolant conducting side of the separator plate, e.g. from the rear to the plane of the drawing. Webs in the plane of the drawing on the side shown form grooves there whereas grooves on the side shown in a view from the other side form webs. The channels for gases that are shown in FIG. 3, for example, are consequently complementary to the channels of interest for the coolant here.

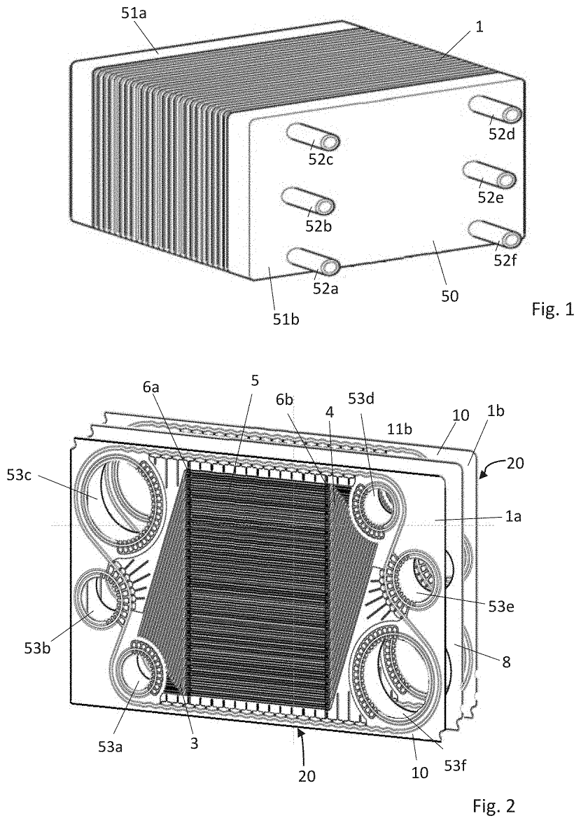

FIG. 1 shows a fuel cell 50 having a first end plate 51a and a second end plate 51b. The two end plates 51a and 51b enclose a plurality of bipolar plates 1 between them. These bipolar plates 1 are supplied with fuel (hydrogen for example) by means of an inflow 52a, with coolant by means of an inflow 52b, and with an oxidant (oxygen or air, for example) by means of an inflow 52c. The outflow 52d serves the draining of unconsumed fuel and reaction products; the outflow 52e serves the draining of coolant; and the outlet 52f serves the draining of unconsumed oxidant.

FIG. 2 shows a sequence of two bipolar plates 1a and 1b that include an ion-conducting polymer membrane (MEA) 8 between them. Each of the bipolar plates 1a and 1b comprises an anode plate 10 and a cathode plate 20 arranged on its rear side and covered by the anode plate in FIG. 2. The cathode plate 20, that cannot be recognized in FIG. 2, is welded to the anode plate 10 which is adjacent to it, whereby a sealed flow region for coolant (more generally: temperature control agent) is produced between the two plates, the anode plate 10 and the cathode plate 20. The bipolar plates 1a and 1b each have passage openings 53a to 53f, so-called “ports”, that serve the supply of fuel (port 53a), the draining of unconsumed fuel and reaction products (port 53d), the supply of coolant (port 53b), the draining of coolant (port 53e), and the supply of oxidizing agent (port 53c), or the draining of unconsumed oxidizing agent (port 53f). The ports 53a to 53f correspond to and are fluidically connected to the connections 52a to 52f in each case in a 1:1 connection ratio.

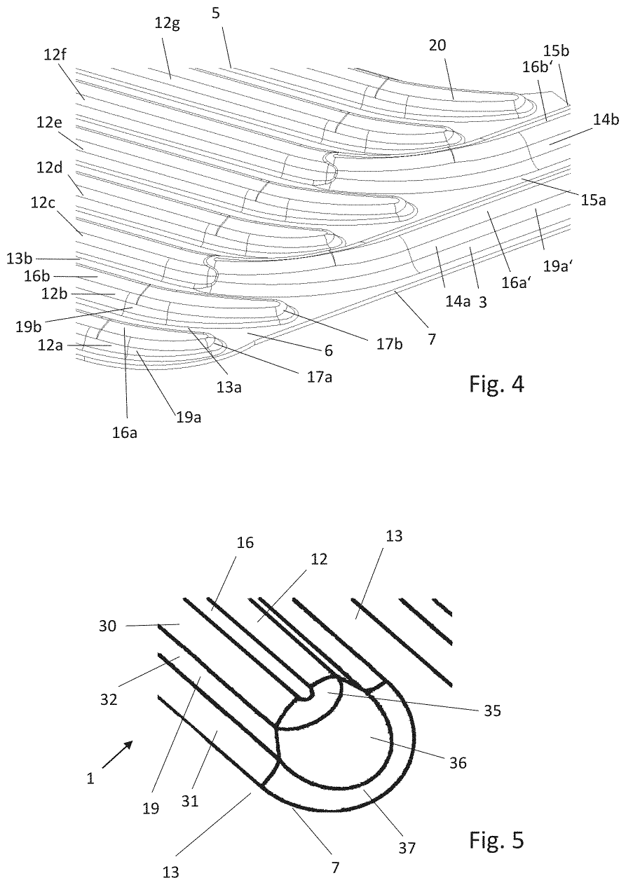

FIG. 3 shows a plan view of a detail of an outer side of a separator plate, for example an anode plate 10, of the bipolar plate 1a. A view of the outer side of the separator plate 10 is shown in FIG. 3. The view of the outer side of the cathode plate 20 is shown in FIGS. 4, 5, 6, and 12 respectively. The channels in accordance with the present disclosure for the coolant are arranged in all the Figures on the side of the separator plate remote from the viewer of the Figures in each case. Since all of the separator plates shown are manufactured from flat metal sheets by a stamping and punching process, lands (webs) to be viewed in these Figures correspond to grooves or channels and the grooves to be viewed in these Figures correspond to lands (webs) on the surface of the separator plate remote from the observer and are also called such in the following.

FIG. 3 shows a separator plate having a port 53a for the supply of fuel, a port 53b for the supply of coolant, and a port 53c for the supply of oxidizing agent. Starting from the port 53a, the fuel flows along a distribution region 3, a flow region 5, and a collection region, not shown, to the outlet port, likewise not shown, for unconsumed fuel and reaction products. The distribution region 3, flow region 5, and collection region 4 have channel structures on the surface of the separator plate, here the anode plate 10, facing the observer. These channel structures are formed by stamped grooves and webs so that correspondingly complementary channel structures are also present on the side of the anode plate 10 remote from the observer.

The channels of the distribution region 3 merge into the channels of the flow region 5 in a transition region 6. The channels of the flow region 5 merge into the channels of the collection region in a transition region, not shown. Corresponding complementary structures are provided for the coolant, as already mentioned above, on the side of the separator plate 10 remote from the observer.

The separator plate 10 can also be a cathode plate, for example.

In the case of an anode plate as a separator plate 10, the coolant that is supplied via the port 53b and is introduced into the intermediate region between the anode plate 10 and the cathode plate, not shown, can then flow along the channel structures of the separator plate arranged on the side remote from the observer and channel structures of the cathode plate from the port 53b via the distribution region 3 to the flow region 5 and flow from there via the collection region to the outlet port from where the coolant can be drained from the fuel cell via a connection (for example stub 52e in FIG. 1).

FIG. 4 shows a detail of a transition region 6 between a distribution region 3 and a flow region 5 in a plan view of the outer side of a conventional separator plate, here now a cathode plate 20. In general, however, an anode plate can also be designed the same as the cathode plate shown here with respect to the present disclosure. A representation and description of an anode plate will therefore be dispensed with here.

The webs shown in FIG. 4 form grooves from the view of the coolant side of the separator plate 20 and are also called such in the following. The recesses between the webs (groove) shown in FIG. 4 form webs between the channel grooves for the coolant in a plan view of the coolant flow side of the separator plate 20. In the following, they are designated and described from the view of the coolant. The observer consequently also has to put himself into the view from the rear of the plane of the drawing in each case in FIG. 4 and also in the following figures.

The flow region 5 has a plurality of grooves 12a, 12b, etc. as first grooves for guiding the coolant. They are separated from one another by webs (lands) 13a, 13b, etc. The distribution region 3 has a plurality of grooves 14a, 14b, etc. as second grooves for guiding the coolant. These grooves 14a, 14b, etc. are separated from one another by webs 15a, 15b, etc. In the plan view of the outer side of the separator plate 20 shown in FIG. 4, the grooves 12a, 12b, 14a, 14b, etc. for guiding the coolant appear as elevated portions and the webs 13a, 13b, 15a, 15b, etc. appear as recesses. These grooves 12a, 12b, 14a, 14b, etc. have groove bases 16a, 16b, 16a′, 16b′, etc. that merge over groove walls 19a, 19b, 19a′, 19b′, etc. into the plane in which the cathode plate 20 already contacts an adjacent anode plate 10. This contact surface is marked by reference numeral 7.

In FIG. 4, two of the grooves 14a, 14b of the distribution region 3 merge directly into two grooves 12c, 12f, of the flow region 5. The grooves 12a, 12b, 12d, 12e, and 12g of the flow region 5 end in the transition region 6 between the flow region 5 and the distribution region 3.

The grooves 14a, 14b of a distribution region 3 are typically deeper than the grooves 12a, 12b, etc. of a flow region since the inserted membrane electrode unit having a gas diffusion layer has a greater thickness in the flow region.

It is now problematic here that both the ends of the grooves 12a, 12b, 12d, 12e, 12g, etc. in the groove walls 19a, 19b, etc. undergo a very great material thinning due to the stamping process and the great height difference there and the transitions between the deeper grooves 14a, 14b, etc. into the less deep grooves 12c, 12f of the flow region 5 are prone to cracks due to the material thinning.

FIG. 5 shows a detail from an end of a groove 12 such as are shown as grooves 12a, 12b, etc. in FIG. 4. The grooves can also be formed in the distribution region at their ends in a form described in the above or in the following, such as in the form shown in FIG. 5, both at the ends facing the flow region 5 and at the ends facing the respective ports 53a to 53f. The groove shown in FIG. 5 in cross-section to its longitudinal extent has a curved region 30, a linearly extending region 32, and a further region 31 curved in the opposite direction by which the groove base 16 is merged into the plane of the contact surface 7 with the adjacent anode plate. A curved region 35, a further intermediate region 36, and a region 37 curved in the opposite direction are likewise provided at the end of the groove 12.

It is disadvantageous in the plates presented in FIG. 4 and in FIG. 5 that the groove base 16 extends in a plane up to the end of the groove 12 so that a very pronounced reshaping of the separator plate 20 takes place in this region on the stamping of the groove 12. This high degree of reshaping results in great material thinning in the groove wall 19 of the groove 12, which can extend up to crack formation. This impairs the permanent durability and the process stability in the manufacture of the separator plate 20. It furthermore results in a high proportion of waste in the manufacture of the separator plate 20.

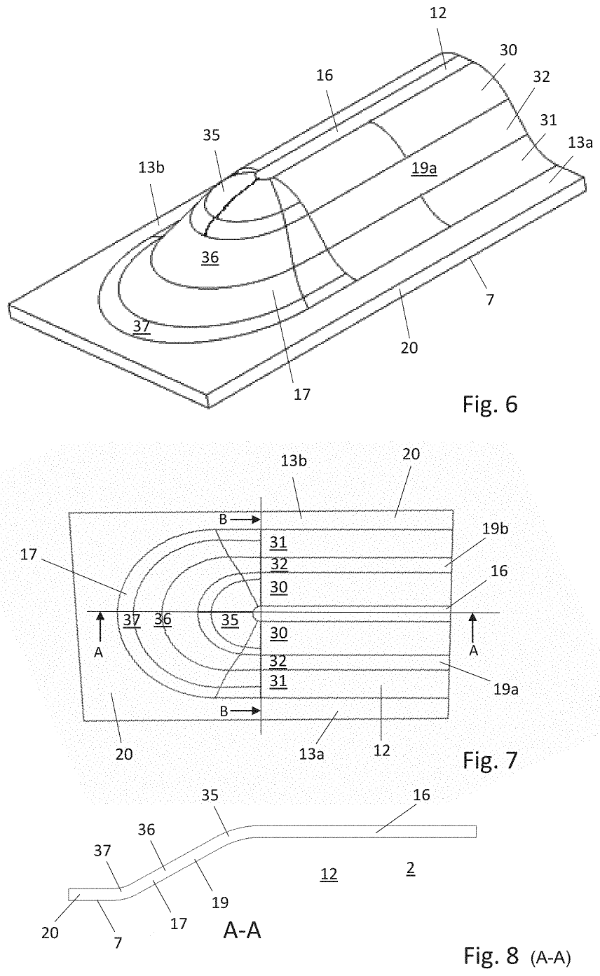

FIGS. 6 to 10 show an example in accordance with the present disclosure of a groove end 17 of a groove 12 of the flow region 5 (but in a plan view of the outer side of the separator plate 20). This end 17 of the groove 12 has a special design with respect to the radii in cross-section transversely to the longitudinal extent of the groove base 16 and with respect to the design of the groove end in the transition from the groove base 16 to the webs 13a, 13b of the separator plate 20 forming the contact surface 7. In a plan view of the end 17 of the groove 12, as shown in FIG. 7, starting from the groove base 16, the groove wall 19a and 19b is designed on both sides of the groove base 16 such that, starting from the groove base 16, a region 30 having a first curvature R1, followed by a transition region 32, and a further curvature region 31 having a radius R2 merges into the adjacent regions of the groove 12 that are represented as webs 13a, 13b from the view of the groove 12. The radius R1 amounts to 0.2 mm in FIG. 7. The radius R2 amounts to 0.305 mm in the present example.

The end of the groove 12 also has a first curvature region 35, that merges into a straight section 36, in the cross-section shown in FIG. 8 in the longitudinal direction of the groove base 16 along the line A-A in FIG. 7. This straight section 36 merges via a further curvature region 37 into the adjacent plane of the separator plate 20 that simultaneously forms the contact surface 7 to the adjacent anode plate. The total length of the rising section, L1 is shown in FIG. 8. It is about the same as or slightly larger than the width B of the groove, which is determined at half its depth, as shown in FIG. 7. The radius R3 of the curved section 35 in which the groove wall 19 merges from the groove base 16 into the straight transition section 36 amounts to 0.6 mm outwardly in the present example. The radius R3 amounts to 0.25 mm in a further example if, for example, the groove end of a groove from the flow region is observed. Tolerances up to 10% of the respective specified values are possible.

The region 36 here extends to the plane of the contact surface 7 or to the plane of the groove base 16 at an angle of 28.9°.

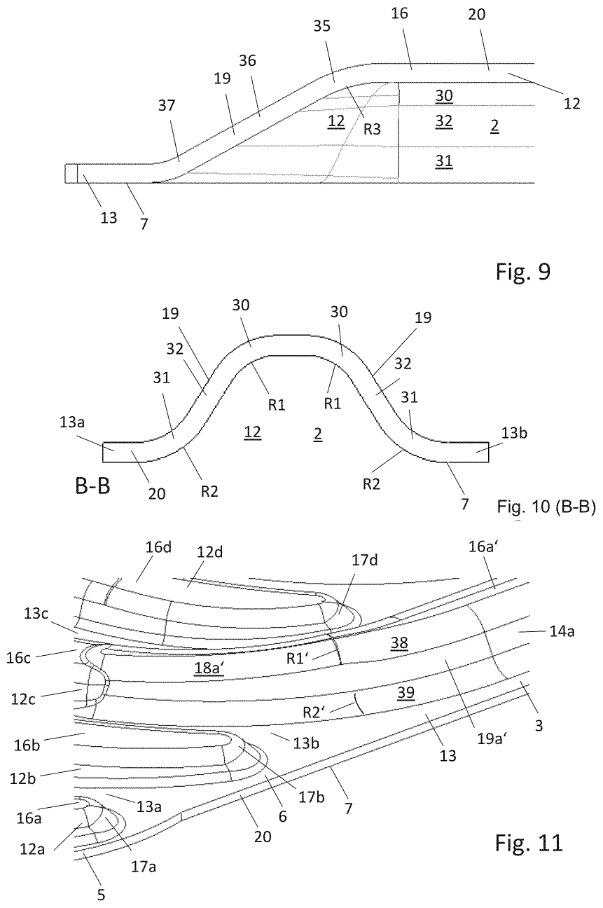

FIG. 9 shows a lateral plan view that corresponds to the section in FIG. 8. In addition, the curvature sections 30, 31 and the transition section 32 located therebetween are shown. The curved section 30 that has a radius R1 extends, starting from the rounded end of the groove 12, up to and into the region in which it extends in parallel with and laterally adjacent to the groove base 16. The radii can project far into the flanks 37 and 32 respectively by using a greater radius R3 and R1 respectively, whereby overall the transition from the groove base 16 to the adjacent webs 13 has to be deformed less overall at the end of the groove 16. Further, FIG. 9 schematically shows the length L2 along which the groove base rises linearly in the direction of the transition region and spans an angle α.

FIG. 10 shows a cross-section along the line B-B through the groove 12 in FIG. 7. The groove base 16 merges via curved regions 30, linear regions 32, and curved regions 31 at both sides of the groove base 16 into the webs 13a, 13b. In further embodiments, the radii R1 and R2 of the regions 30 and 31 are selected such that the inner radius of the region 30 is R1 and the outer radius of the region 30 is R2. The radii can be correspondingly swapped over in the region 31 so that the inner radius of the region 31 amounts to R2 and the outer radius of the region 31 amounts to R1.

FIG. 11 shows a detail of FIG. 4. The end 17c of the groove 12c of the flow region 5 merges into the end 18a′ of the groove 14a. In this transition region, the groove base 16a′ of the groove 14a, is raised, starting from the distribution region 3, in the region of the flow region 5 in the transition region 6 so that the distance between the webs 13b, 13c and the groove base 16a′ of the groove 14a is reduced in the direction of the groove 12c. The height difference between the groove base 16a′ and the groove base 16c of the groove 12c is thereby simultaneously reduced. Such a raising of the groove base 16a′ may be advantageous when it takes place over a longer distance, for example over at least 1 mm. The groove 14a in the transition region can furthermore be designed such that the groove base 16a′ takes place into the adjacent webs 13b, 13c by a sequence of a curvature region 38 having a radius R1′, an intermediate region, and a curvature region 39 having a radius R2′. R1′ and R2′ amount to 0.165 mm and 0.275 mm respectively in the present example.

In a similar manner to the groove base 16a′ being raised from the distribution region 4 in the transition region 6 to the flow region 5, the groove base of the grooves 12a, 12b, and 12d, that end in the transition region 6, is raised, starting from the flow region 5, toward its end 17a, 17b, and 17d in the transition region 6. The height difference to be overcome at the end of the groove bases 16a, 16b, 16d from the adjacent plane of the separator plate 20 that forms the contact surface 7 to the anode plate is hereby reduced. The distortion of the groove walls of the grooves 12a, 12b, and 12d can likewise be reduced at their ends 17a, 17b, and 17d through such a raising over a long distance.

FIGS. 1-11 are shown approximately to scale. FIGS. 1-11 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” or “substantially” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A bipolar plate having an anode plate and a cathode plate of which a respective one of their surfaces are arranged adjacent to one another forming a contact surface between the two surfaces,
wherein hollow spaces are formed between the two plates as a distribution region, a collection region, and a flow region arranged between the distribution region and the collection region to guide the coolant;
wherein the flow region in each of the plates has a first group of first grooves that are arranged transversely to their longitudinal directions adjacent to one another and separated from one another by first webs to guide the coolant in the first grooves;
wherein the distribution region and the collection region in each of the plates each have a second group of second grooves that are arranged transversely to their longitudinal directions adjacent to one another and separated from one another by second webs to guide the coolant in the first grooves, and
having a transition region in which at least one first groove ends and/or a second groove ends or at least one first groove merges into a second groove,
wherein, for at least one of the first grooves and second grooves, the groove base rises, starting in the flow region, in the distribution region, and/or in the collection region, in the direction of the transition region and/or in the transition region such that the distance of the groove base from the contact surface decreases.

2. The bipolar plate in accordance with claim 1, wherein at least one of the first grooves and second grooves ends in the transition region.

3. The bipolar plate in accordance with claim 1, wherein at least one of the second grooves merges into a first groove at its end in the transition region.

4. The bipolar plate in accordance with claim 1, wherein, at least for one of the first grooves and second grooves, the groove base rises over a length L1, with L1 amounting to at least 1 mm.

5. The bipolar plate in accordance with claim 4, wherein, at least for one of the first grooves and second grooves, the groove has a width B to which L1≥B applies, where the width B is determined at half depth of the groove.

6. The bipolar plate in accordance with claim 1, wherein, at least for one of the first grooves and second grooves, the rise of the groove base is linear over a length L2; and/or in that in the rise of the groove base the plane of the groove base with the plane of the contact surface directly at both sides of the groove, at least sectionally, forms an angle α with α≤10°.

7. The bipolar plate in accordance with claim 1, wherein, for at least one of the first grooves and second grooves that end in the transition region, the groove has a first curvature region having a radius R1 in which the groove base merges into the groove wall and a second curvature region having the radius R2 in which the groove wall merges into the regions adjacent to the groove of the respective associated plate, in the cross-section perpendicular to its longitudinal extent along the rise of the groove base and measured on the inner side of the groove.

8. The bipolar plate in accordance with claim 7, wherein the first curvature region and the second curvature region are spaced apart from one another by an intermediate region of the groove wall.

9. The bipolar plate in accordance with claim 7, wherein the radius R1 is at least regionally constant in the longitudinal extent of the groove along the rise of the groove base; and/or the radius R2 is at least regionally constant in the longitudinal extent of the rise of the groove base.

10. The bipolar plate in accordance with claim 7, wherein the radius R1 is at least regionally constant in the longitudinal extent of the groove along the rise of the groove base; and/or the radius R2 is at least regionally constant in the longitudinal extent of the rise of the groove base, and wherein 0.04 mm≤R1≤0.30 mm and/or 0.11 mm≤R2≤0.33 mm.

11. The bipolar plate in accordance with claim 7, wherein the radius R1 is at least regionally constant in the longitudinal extent of the groove along the rise of the groove base; and/or the radius R2 is at least regionally constant in the longitudinal extent of the rise of the groove base, and wherein the radius of the plate is substantially equal to the radius R1 in a region of one of the two surfaces of the plate disposed opposite the surface having the radius R2 at the outer side with respect to the groove.

12. The bipolar plate in accordance with claim 1, wherein at least one of the first grooves or second grooves that merge at their end in the transition region into a second groove or a first groove, has a fifth curvature region having a radius R1′ in which the groove base merges into the groove wall, and a sixth curvature region having the radius R2′ in which the groove wall merges into the regions of the plate adjacent to the groove, in cross-section perpendicular to the longitudinal extent along the rise of the groove base and measured on the inner side of the groove; and
wherein the radius R1′ is at least regionally constant in the longitudinal extent of the groove along the rise of the groove base; and/or the radius R2′ is at least regionally constant in the longitudinal extent of the rise of the groove base.

13. The bipolar plate in accordance with claim 12, characterized by 0.225 mm≤R1′≤0.375 mm and/or 0.125 mm≤R2′≤0.215 mm.

14. The bipolar plate in accordance with claim 12, wherein the radius of the plate is substantially equal to the radius R1′ in a region of one of the surfaces of the plate disposed opposite the surface having the radius R2′ at the outer side with respect to the groove.

15. The bipolar plate in accordance with claim 1, wherein at least one of the first grooves and second grooves that end in the transition region at its end has a third curvature region having a radius R3 in which the groove base merges into the groove wall in a cross-section along its longitudinal extent and measured on the inner side of the groove.

16. The bipolar plate in accordance with claim 15, characterized by 0.24 mm≤R3≤1.5 mm.

17. A fuel cell having one or more bipolar plates in accordance with claim 1.
